(19) United States
(12) Patent Application Publication
(10) Pub. No.: US 2026/0349583 A1
(43) Pub. Date: Nov. 5, 2026

(54) METHOD, APPARATUS, DEVICE, STORAGE MEDIUM, AND COMPUTER PROGRAM PRODUCT FOR PAGE INTERACTION

(71) Applicant: Beijing Zitiao Network Technology Co., Ltd., Haidian District, Beijing (CN)

(72) Inventors: Qi SHI, Beijing (CN); Peiyin LIN, Beijing (CN); Zijian ZHANG, Beijing (CN)

(21) Appl. No.: 19/485,979

(22) PCT Filed: Nov. 28, 2024
(86) PCT No.: PCT/CN2024/135190

§ 371 Date: Nov. 19, 2025

(30) Foreign Application Priority Data
Apr. 24, 2024 (CN) 202410502518.9

(51) Int. Cl. G06F 3/0483; G06F 3/0482; G06F 40/35

(52) U.S. Cl. CPC G06F 3/0483; G06F 3/0482; G06F 40/35

(57) ABSTRACT

According to embodiments of the disclosure, a method, an apparatus, a device, and a storage medium for page interaction are provided. The method includes: detecting whether a target story that a user is interacting with has ended, the target story involving a plurality of characters and a storyline of the target story being triggered based on setting information of the target story and dialogues between the user and the plurality of characters; and presenting an ending page corresponding to the target story in response to detecting that the target story has ended, the ending page including at least an interaction summary for the target story, the interaction summary being generated based at least on the storyline triggered by the user in the target story.

The present application claims priority to Chinese Patent Application No. 202410502518.9, filed on Apr. 24, 2024, and entitled “METHOD, APPARATUS, DEVICE, STORAGE MEDIUM, AND COMPUTER PROGRAM PRODUCT FOR PAGE INTERACTION”, which is incorporated herein by reference in its entirety.

### FIELD

Example embodiments of the present disclosure generally relate to the field of computers, and in particular, to a method, an apparatus, a device, a computer-readable storage medium, and a computer program product for page interaction.

### BACKGROUND

With the rapid development of Internet technologies, various applications have become important tools in the daily lives of people. Different applications often have different functions, and users may implement specific services through specific applications with specific functions. As an application with strong interactivity, conversational applications are widely embraced by users. Through the conversational application, the users may talk and interact with virtual characters.

In recent years, conversational applications with storylines have gradually come into public view. Specifically, users may advance the process of a predetermined storyline by having dialogues with a virtual character in the story. At the end of the story, an ending page is usually presented to the user. Most of the existing ending pages are preset and cannot meet the personalized needs of users.

### SUMMARY

In a first aspect of the present disclosure, a method for page interaction is provided. The method includes: detecting whether a target story that a user is interacting with has ended, the target story involving a plurality of characters and a storyline of the target story being triggered based on setting information of the target story and dialogues between the user and the plurality of characters; and presenting an ending page corresponding to the target story in response to detecting that the target story has ended, the ending page including at least an interaction summary for the target story, the interaction summary being generated based at least on the storyline triggered by the user in the target story.

In a second aspect of the present disclosure, an apparatus for page interaction is provided. The apparatus includes: a story end detection module configured to detect whether a target story that a user is interacting with has ended, the target story involving a plurality of characters and a storyline of the target story being triggered based on setting information of the target story and dialogues between the user and the plurality of characters; and an ending page presentation module configured to present an ending page corresponding to the target story in response to detecting that the target story has ended, the ending page including at least an interaction summary for the target story, the interaction summary being generated based at least on the storyline triggered by the user in the target story.

In a third aspect of the present disclosure, an electronic device is provided. The device includes at least one processing unit; and at least one memory coupled to the at least one processing unit and storing instructions for execution by the at least one processing unit, where the instructions, when executed by the at least one processing unit, cause the electronic device to perform the method of the first aspect.

In a fourth aspect of the present disclosure, a computer-readable storage medium is provided. The computer-readable storage medium has a computer program stored thereon, the computer program being executable by a processor to implement the method of the first aspect.

In a fifth aspect of the present disclosure, a computer program product is provided. The computer program product is tangibly stored in a computer storage medium and includes computer-executable instructions, the computer-executable instructions, when executed by a device, causing the device to perform the method of the first aspect or the second aspect.

It would be appreciated that the content described in the Summary section of the present disclosure is neither intended to identify key or essential features of the embodiments of the present disclosure, nor is it intended to limit the scope of the present disclosure. Other features in the present disclosure will become readily understood from the following description.

### BRIEF DESCRIPTION OF THE DRAWINGS

The above and other features, advantages, and aspects of the embodiments of the present disclosure will become more apparent in combination with the drawings and with reference to the following detailed description. In the drawings, the same or similar reference numbers refer to the same or similar elements, where:

FIG. 1 illustrates a schematic diagram of an example environment in which embodiments according to the present disclosure may be implemented;

FIG. 2 illustrates a schematic diagram of an example interface for page interaction according to some embodiments of the present disclosure;

FIG. 3 illustrates a schematic diagram of an example interface for page interaction according to some embodiments of the present disclosure;

FIGS. 4A and 4B show schematic diagrams of example interfaces for page interaction according to some embodiments of the present disclosure;

FIG. 5 illustrates a flowchart of a method for page interaction according to some embodiments of the present disclosure;

FIG. 6 illustrates a schematic structural block diagram of an apparatus for page interaction according to some embodiments of the present disclosure; and

FIG. 7 illustrates a block diagram of an electronic device in which one or more embodiments of the present disclosure may be implemented.

### DETAILED DESCRIPTION OF EMBODIMENTS

The embodiments in the present disclosure will be described in more detail below with reference to the accompanying drawings. Although certain embodiments in the present disclosure are shown in the drawings, it would be appreciated that the present disclosure can be implemented in various forms and should not be interpreted as limited to the embodiments described in this specification. On the contrary, these embodiments are provided for a more thorough and complete understanding in the present disclosure. It would be appreciated that the accompanying drawings and embodiments in the present disclosure are only for the purpose of illustration and are not intended to limit the scope of protection in the present disclosure.

In the description of the embodiments of the present disclosure, the term “including” and similar terms would be appreciated as open-ended inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below.

Herein, unless expressly stated herein, performing a step “in response to A” does not mean that the step is performed immediately after “A”, but may include one or more intermediate steps.

It would be appreciated that the data involved in this technical solution (including but not limited to the data itself, data acquisition or use) shall comply with the requirements of corresponding laws, regulations and relevant provisions.

It would be appreciated that before the technical solution disclosed in the embodiments in the present disclosure is used, users should be informed of the type, the scope of use, the use scenario, etc. of the personal information involved in the present disclosure in an appropriate manner and in accordance with relevant laws and regulations, and the authorization of the users may be obtained.

For example, in response to an active request being received from a user, a prompt message is sent to the user to explicitly prompt the user that the operation requested by the user would need acquisition and use of personal information of the user. As such, according to prompt information, users may choose whether to provide personal information to the software or hardware, such as an electronic device, application, server or storage medium, that performs the operations of the technical solution in the present disclosure.

As an optional but non-limiting implementation, in response to the active request being received from the user, the prompt information may be sent to the user via, for example, a pop-up window in which the prompt information may be presented in text. In addition, the pop-up window may also contain selection controls configured for the user to choose “agree” or “disagree” to provide the personal information to the electronic device.

It would be appreciated that the above process of notification and acquisition of user authorization is only illustrative and does not limit the implementations in the present disclosure. Other methods that meet relevant laws and regulations may also be applied to the implementations in the present disclosure.

The term “in response to” used herein represents a state in which a corresponding event occurs or a condition is satisfied. It would be appreciated that there is not necessarily a strong correlation between a time at which a subsequent action performed in response to the event or condition is executed and a time at which the event occurs or the condition is satisfied. For example, in some cases, the subsequent action may be performed immediately when the event occurs or the condition is satisfied, while in other cases, the subsequent action may be performed after a period of time has elapsed since the event occurred or the condition has been satisfied.

In recent years, conversational applications with storylines have gradually come into public view. Specifically, users may advance the process of a predetermined storyline by having dialogues with a virtual character in the story. At the end of the story, an ending page is usually presented to the user. Most of the existing ending pages are preset and cannot meet the personalized needs of users.

According to various embodiments of the present disclosure, a solution for page interaction is proposed. In this solution, a terminal device detects whether a target story that a user is interacting with has ended, the target story involving a plurality of characters and a storyline of the target story being triggered based on setting information of the target story and dialogues between the user and the plurality of characters; and the terminal device presents an ending page corresponding to the target story in response to detecting that the target story has ended, the ending page including at least an interaction summary for the target story, the interaction summary being generated based at least on the storyline triggered by the user in the target story. In this way, a personalized ending page may be generated.

The embodiments of the present disclosure will be further described below in conjunction with the drawings.

### Example Environment

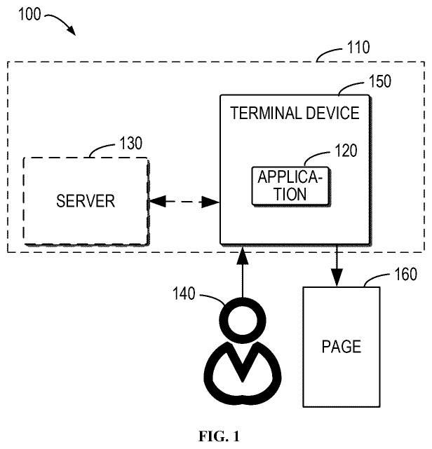

FIG. 1 illustrates a schematic diagram of an example environment 100 in which embodiments of the present disclosure may be implemented. In this example environment 100, an application 120 is installed on a terminal device 150. A user 140 may interact with the application 120 via the terminal device 150 and/or an attached device of the terminal device 150.

In the environment 100 of FIG. 1, if the application 120 is active, the terminal device 150 may present a page 160 of the application 120. The page 160 may include various types of pages that may be provided by the application 120, such as an information display page, a dialogue window, a personal homepage, and so on.

In some embodiments, the terminal device 150 may communicate with a server 130 to enable provision of services of the application 120. The terminal device 150 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a TV receiver, a radio broadcast receiver, an e-book device, a gaming device, or any combination thereof, including the accessories and peripherals of these devices, or any combination thereof. In some embodiments, the terminal device 110 may also support any type of user-specific interface (such as “wearable” circuitry, etc.). The server 130 may be various types of computing systems/servers capable of providing computing power, including but not limited to mainframes, edge computing nodes, computing devices in cloud environments, and so on.

In some embodiments, the terminal device 150 and the server 130 may cooperate to provide a specific service for the user 140. In some example embodiments of the present disclosure, an example process is described with the terminal device 150 as an execution body. It would be appreciated that the described example process may be implemented through cooperation between the terminal device 150 and the server 130. For the sake of brevity, the same or similar content will not be repeated.

It would be appreciated that the structure and function of each element in the environment 100 are described for illustrative purposes only, without suggesting any limitation to the scope of the present disclosure. Various example implementations of the present disclosure will be described in detail below.

### Example Process

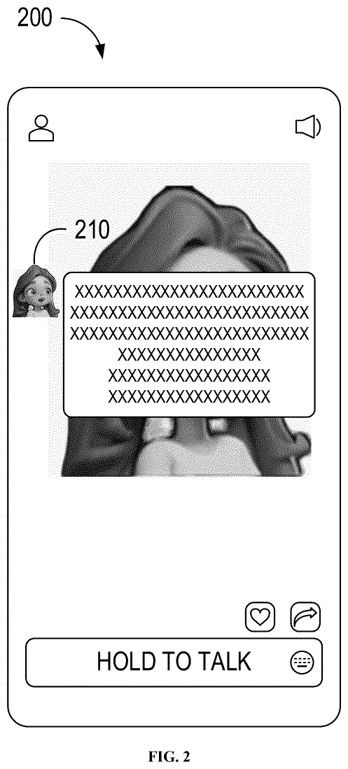

For a better understanding of the embodiments of the present disclosure, reference is made to example user interfaces 200 to 400B shown in FIGS. 2 to 4B in the following example embodiments. It would be appreciated that the user interfaces shown in FIGS. 2 to 4B are only examples, and various designs may be used in practice. For example, the various graphic elements and/or controls in the user interface may have different arrangements and different visual representations, one or more of the elements and/or controls may be omitted or replaced, and there may also be one or more other elements and/or controls. In addition, the user interface may contain any appropriate content. The scope of the present disclosure is not limited in this regard.

In the example embodiments of the present disclosure, the example user interfaces 200 to 400B may be implemented at the terminal device 150, which may be any page of the application 120.

In the embodiments of the present disclosure, the application 120 may be a conversational application. Specifically, the user may interact with a virtual character in the form of a dialogue. Herein, the virtual character may sometimes be simply referred to as a character.

In some embodiments, each character has a certain character setting, including but not limited to, gender, age, personality, and so on. The terminal device 150 may implement dialogue interaction between the character and the user based on the character setting. Furthermore, in some embodiments, each character may be associated with a plurality of stories. In this case, the user and the character may advance the process of a predetermined storyline through dialogues, according to a preset story setting. In short, in the various embodiments of the present disclosure, the user may have a storyline-based dialogue with a specific character, or may have a storyline-independent dialogue with the character. Reference is made to the example user interface 200 shown in FIG. 2. In this example user interface 200, the user may have a dialogue with a character 210. Furthermore, in some embodiments, the user 140 may have the dialogue with the character by text and/or voice.

As discussed below, according to the various embodiments of the present disclosure, a personalized ending page may be presented in response to detecting that a target story being interacted with has ended.

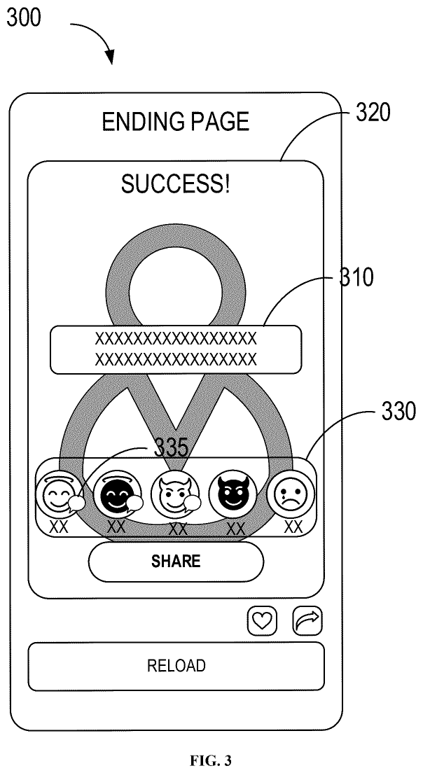

In operation, the terminal device 150 detects whether a target story that the user is interacting with has ended. In response to detecting that the target story has ended, the terminal device 150 presents an ending page corresponding to the target story. According to the various embodiments of the present disclosure, the ending page includes at least an interaction summary for the target story, the interaction summary being generated based at least on a storyline triggered by the user in the target story. Reference is made to the example user interface 300 shown in FIG. 3, which illustrates the ending page of the target story. The example user interface 300 includes an interaction summary 310.

In a story-based conversational game, advancement of the plot of the story mainly relies on dialogues between the user and the character, which results in a close relationship between the behavior of the user and the storyline. In this case, generating the interaction summary based on the storyline may not only meet the personalized needs of the user, but also enhance the sense of immersion of the user in the game.

In some embodiments, the interaction summary is generated based on at least dialogues between the user and at least one of the plurality of characters in the storyline. Alternatively or in addition, in some embodiments, the interaction summary is also generated based on character setting information of at least one of the plurality of characters, for example, based on the gender, age, personality, and so on of the character.

In some embodiments, the character setting information of the at least one character indicates at least a speaking style of the at least one character, for example, the speaking style may be short and concise, critical, encouraging, etc. In this way, the interaction summary will be generated in a specific tone of the character in the story, so that the generated interaction summary better matches the story.

In some embodiments, the at least one character providing the interaction summary is selected from the plurality of characters based on a degree of closeness between each of the plurality of characters and the user in the storyline. For example, in the target story, the relationship between a character and the user may be a couple, girlfriends, ordinary friends, etc. In this case, a character with a high level of intimacy may be selected, and the interaction summary may be generated based on the character setting of this character.

Alternatively or in addition, in some embodiments, the at least one character providing the interaction summary is selected based on a frequency of interaction between each of the plurality of characters and the user in the storyline, for example, based on the number of dialogues between the user and the plurality of characters in the target story.

Alternatively or in addition, in some embodiments, the at least one character providing the interaction summary is selected based on character setting information of each of the plurality of characters in the target story. For example, the plurality of characters include a leader, a prophet, a programmer, and so on. In this case, a character corresponding to the leader may be selected, and the interaction summary may be generated based on the character setting of this character.

In some embodiments, the at least one character is selected by the user. For example, if the user is particularly interested in one of the characters, the user may specify that the interaction summary be generated based on the character setting of this character.

In some embodiments, the interaction summary includes a summary part corresponding to each of the at least one of the plurality of characters, where the summary part corresponding to each character is also generated based on at least one of the following: dialogues between the user and the character in the storyline, or the character setting information of the character. In an example, the interaction summary includes a summary part corresponding to one selected specific character. In another example, the interaction summary includes a plurality of sub-interaction summaries, each sub-interaction summary corresponding to one of a plurality of selected specific characters, for example, the interaction summary includes a first sub-interaction summary generated based on a character setting of a first character, a second sub-interaction summary generated based on a character setting of a second character, and so on. In yet another example, the interaction summary may be generated based on all the characters in the target story, that is, the interaction summary includes plurality of sub-interaction summaries, each sub-interaction summary corresponding to one character in the target story.

Additionally, in some embodiments, when the interaction summary includes the plurality of sub-interaction summaries, the plurality of sub-interaction summaries may be displayed in a scrolling or alternating manner. In this way, the content of the interaction summary is enriched, and a bad reading experience caused by providing too much information to the user in a short period of time may be avoided.

In addition to the interaction summary, according to some embodiments of the present disclosure, the ending page may further include an image. Reference is made to the example user interface 300 shown in FIG. 3, which illustrates the ending page of the target story. The example user interface 300 includes a picture 320. In some embodiments, the image is generated based on at least one of the following: the interaction summary, the storyline of the target story, an ending of the target story, dialogues between the user and the plurality of characters in the storyline, or character setting information of the at least one of the plurality of characters.

In some embodiments, the image is generated with an image generation model. As an example, one or more of the interaction summary, the storyline of the target story, the ending of the target story, the dialogues between the user and the plurality of characters in the storyline, or the character setting information of the at least one of the plurality of characters may be used as input to the model, so that the model generates a more personalized image that is more consistent with the storyline.

Alternatively or in addition, in some embodiments, the image presents an image identification of the user and the at least one of the plurality of characters, for example, a synthesized group photo of the user and one or more characters.

As discussed above, the interaction summary may include a plurality of sub-interaction summaries, and the plurality of sub-interaction summaries may be displayed in a scrolling or alternating manner. In this case, when the plurality of sub-interaction summaries are displayed in a scrolling or alternating manner, the pictures may be dynamically switched accordingly. For example, when a sub-interaction summary corresponding to character A is displayed, a group photo with character A is displayed, and when a sub-interaction summary corresponding to character B is displayed, a group photo with character B is displayed.

In some embodiments, the ending page further includes a character list. Reference is made to the example user interface 300 shown in FIG. 3. The example user interface 300B includes a character display panel/character list 330.

Generally speaking, a story may be associated with a plurality of characters, some of which are non-interactable characters. In some embodiments, if a character is interactable, an entry control associated with the character is further presented in the character list of the ending page.

Additionally, the user needs to be informed which characters are interactable and which characters are not. In some embodiments, an interaction indication identification may be presented in association with an identification of the character, the interaction indication identification indicating that the character is separately interactable, that is, after the entry control associated with the character is triggered, the character page associated with the character may be presented. In the example user interface 300, an interaction indication identification 335 is displayed.

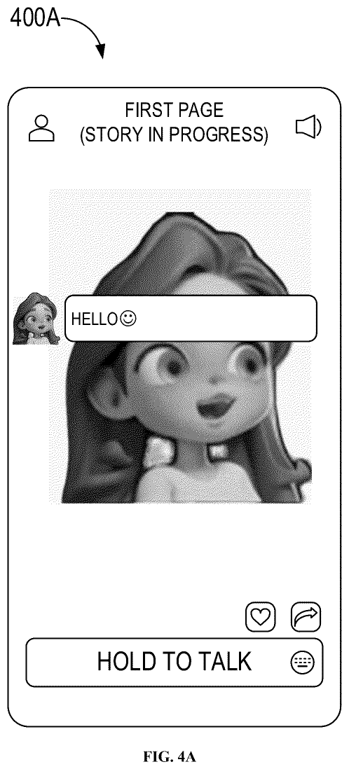

In some embodiments, a character page associated with a first character is presented in response to detection of a trigger on an entry control associated with the first character in the character list. In an example, the character page is a dialogue window between the user and the first character, as shown in an example user interface 400A of FIG. 4A. In another example, the character page includes a list of stories involving the first character. Additionally, in some embodiments, the list includes at least one of the following: introduction information of each story involving the first character, or character description information of the first character in each story. Reference is made to FIG. 4B, which illustrates an example user interface 400B. In the example user interface 400B, a list of stories of the first character is presented, including stories 410 to 440.

In some embodiments, the character page includes a list of stories involving the first character, and a third page associated with a second story is presented by the terminal device 150 in response to detection of a selection of the second story from the list of stories involving the first character. For example, if the user selects the story 410, a chat interface with the first character may be jumped to. In this chat interface, the user may advance the process of the story 410 based on dialogues with the first character.

In some embodiments, an order of the plurality of characters in the character list is based on an order in which the plurality of characters appear in the target story. Alternatively or in addition, in some embodiments, the order of the plurality of characters in the character list is based on an intimacy level of interaction between each of the plurality of characters and the user in the target story, for example, a number of dialogues with the user. Alternatively or in addition, in some embodiments, the order of the plurality of characters in the character list is based on a character relationship between each of the plurality of characters and the user in the target story, for example, friends, a couple, etc. Alternatively or in addition, in some embodiments, the order of the plurality of characters in the character list is based on an overall intimacy level of interaction between each of the plurality of characters and the user in the respective stories involving the plurality of characters, for example, a number of stories in which the character participates together with the user. In this way, the presentation order of the characters is more flexible and reasonable.

Generally speaking, different characters have different appearance times in the story. In some cases, the user expects to quickly jump to a chapter related to the character.

In some embodiments, the dialogue window with the first character is associated with the target story. In other words, in response to a trigger operation on the entry control of the first character, the terminal device 150 may position the process of the target story to a chapter involving the first character.

Additionally, in some embodiments, in response to detecting the trigger on the entry control associated with the first character, the terminal device 150 presents story chapters (for example, a chapter list) in the target story in which an interaction with the first character is required. In response to detecting a selection of a story chapter to interact with the first character, the terminal device 150 may position the process of the target story to the selected story chapter.

In some embodiments, whether to present the dialogue window or the story list of the first character after the entry control is triggered may be based on the selection of the user. Specifically, in response to detecting the trigger on the entry control associated with the first character of the plurality of characters, the terminal device 150 presents a first option corresponding to the dialogue window and a second option corresponding to the list of stories involving the first character. A character page including the dialogue window is presented in response to detecting a selection of the first option, and a character page including the list of stories involving the first character is presented in response to detecting a selection of the second option.

In this way, the user may flexibly determine the way to further interact with the selected character. For example, if the user wants to have a storyline-independent chat with the first character, the user may select the first option. If the user desires to advance another story process with the first character, the user may choose the second option.

According to some embodiments of the present disclosure, the user may also share one or more specific characters with other users, so that the other users may further interact with the character(s), for example, have dialogues with the character(s) or advance a story process with the character(s).

Specifically, in some embodiments, in response to detecting a sharing request for a second character in the character list (for example, clicking a sharing control), the terminal device 150 receives an indication of a shared user of the second character. In this case, the terminal device 150 may send an access link corresponding to a character page associated with the second character to the shared user.

Furthermore, the user may also receive sharing links from other users. In this case, the user may click on the sharing link to further interact with the character. The sharing operation may make the game more interesting and enhance the interaction between users.

### Example Method

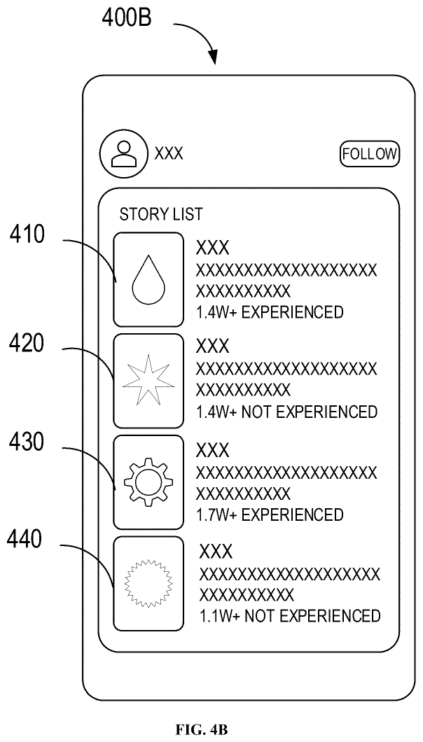

FIG. 5 illustrates a flowchart of a method 500 for page interaction according to some embodiments of the present disclosure. The method 500 may be implemented at the terminal device 150 (or jointly implemented by the terminal device 150 and the server 130). For the convenience of discussion, in the following example embodiments, the process 500 is implemented at the terminal device 150. The process 500 is described below with reference to FIG. 1.

At block 510, the terminal device detects whether a target story that a user is interacting with has ended, the target story involving a plurality of characters and a storyline of the target story being triggered based on setting information of the target story and dialogues between the user and the plurality of characters.

At block 520, the terminal device 150 presents an ending page corresponding to the target story in response to detecting that the target story has ended, the ending page including at least an interaction summary for the target story, the interaction summary being generated based at least on the storyline triggered by the user in the target story.

In some embodiments, the interaction summary is generated based at least on a dialogue between the user and at least one character of the plurality of characters in the storyline.

In some embodiments, the interaction summary is further generated based on character setting information of at least one character of the plurality of characters.

In some embodiments, the character setting information of the at least one character indicates at least a speaking style of the at least one character.

In some embodiments, the at least one character is selected from the plurality of characters based on at least one of: a frequency of interaction between the respective one of the plurality of characters and the user in the storyline, or respective character setting information of the plurality of characters in the target story.

In some embodiments, the interaction summary includes a summary part corresponding to the at least one character of the plurality of characters, the summary part corresponding to each character being further generated based on at least one of: a dialogue between the user and the character in the storyline, or character setting information of the character.

In some embodiments, the at least one character is selected by the user.

In some embodiments, the ending page further includes an image generated based on at least one of: the interaction summary, the storyline of the target story, an ending of the target story, dialogues between the user and the plurality of characters in the storyline, or character setting information of at least one character of the plurality of characters.

In some embodiments, the image is generated with an image generation model, and/or where the image presents an image identification of the user and at least one character of the plurality of characters.

In some embodiments, the ending page further includes a character list, and in the character list, at least one character of the plurality of characters is associated with an entry control. The terminal device presents a character page associated with a first character in response to detecting a trigger of an entry control associated with the first character in the character list, the character page including at least one of: a dialogue window between the user and the first character, or a list of stories involving the first character.

In some embodiments, the terminal device 150 presents a first option corresponding to the dialogue window and a second option corresponding to the list of stories involving the first character in response to detecting the trigger of the entry control associated with the first character; presents the character page including the dialogue window in response to detecting a selection of the first option; and presents the character page including the list of stories involving the first character in response to detecting a selection of the second option.

In some embodiments, an order of the plurality of characters in the character list is determined based on at least one of: an occurrence order of the plurality of characters in the target story, a degree of closeness of interactions between the plurality of characters and the user in the target story, a character relationship between the plurality of characters and the user in the target story, or a degree of overall closeness of interactions between the plurality of characters and the user in respective stories involving the plurality of characters.

In some embodiments, the dialogue window with the first character is associated with the target story, and the terminal device 150 positions a process of the target story to a chapter involving the first character.

In some embodiments, in response to detecting the trigger of the entry control associated with the first character, the terminal device 150 presents a story chapter in the target story in which an interaction with the first character is required; and in response to detecting a selection of the story chapter in which the interaction with the first character is performed, the terminal device 150 positions the process of the target story to a selected story chapter.

In some embodiments, the character page includes the dialogue window between the user and the first character, and in the dialogue with the first character, the terminal device 150 determines a reply of the first character to the user based on at least one of: character setting information of the first character, historical dialogue information between the first character and the user in the target story, or historical dialogue information of the first character in stories other than the target story.

In some embodiments, the character page includes the list of stories involving the first character, the list including at least one of: introduction information of each story involving the first character, or character description information of the first character in each story.

In some embodiments, the character page includes the list of stories involving the first character, and the terminal device 150 presents a third page associated with a second story in response to detecting a selection of the second story from the list of stories involving the first character.

In some embodiments, in response to detecting a sharing request for a second character in the character list, the terminal device receives an indication of a user with whom a second character is shared; and sends an access link corresponding to the character page associated with the second character to the user with whom the second character is shared.

### Example apparatus and device

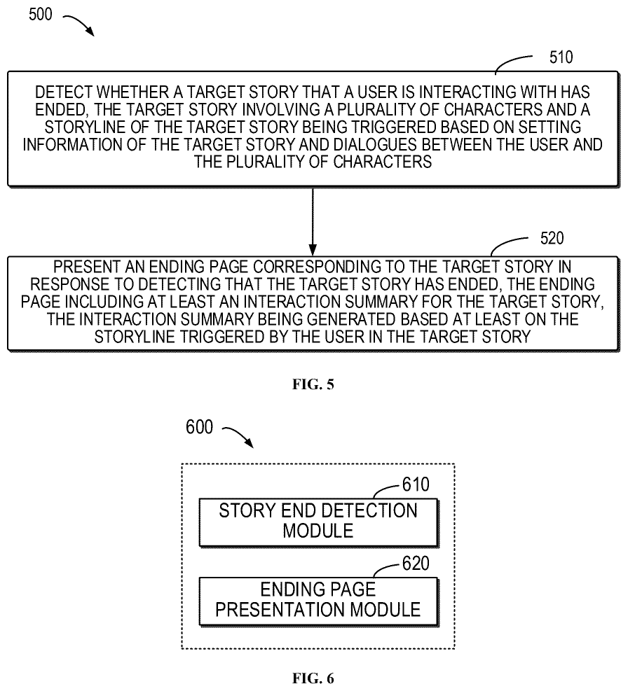

FIG. 6 illustrates a schematic structural block diagram of an apparatus 600 for page interaction according to some embodiments of the present disclosure. The apparatus 600 may be implemented as or included in the terminal device 150. Each module/component in the apparatus 600 may be implemented by hardware, software, firmware, or any combination thereof.

As shown in FIG. 6, the apparatus 600 for page interaction includes: a story end detection module 610 configured to detect whether a target story that a user is interacting with has ended, the target story involving a plurality of characters and a storyline of the target story being triggered based on setting information of the target story and dialogues between the user and the plurality of characters; and an ending page presentation module 620 configured to present an ending page corresponding to the target story in response to detecting that the target story has ended, the ending page including at least an interaction summary for the target story, the interaction summary being generated based at least on the storyline triggered by the user in the target story.

In some embodiments, the interaction summary is generated based at least on a dialogue between the user and at least one character of the plurality of characters in the storyline.

In some embodiments, the interaction summary is further generated based on character setting information of at least one character of the plurality of characters.

In some embodiments, the character setting information of the at least one character indicates at least a speaking style of the at least one character.

In some embodiments, the at least one character is selected from the plurality of characters based on at least one of: a degree of closeness between a respective one of the plurality of characters and the user in the storyline, a frequency of interaction between the respective one of the plurality of characters and the user in the storyline, or respective character setting information of the plurality of characters in the target story.

In some embodiments, the interaction summary includes a summary part corresponding to the at least one character of the plurality of characters, the summary part corresponding to each character being further generated based on at least one of: a dialogue between the user and the character in the storyline, or character setting information of the character.

In some embodiments, the at least one character is selected by the user.

In some embodiments, the ending page further includes an image, the image being generated based on at least one of: the interaction summary, the storyline of the target story, an ending of the target story, dialogues between the user and the plurality of characters in the storyline, or character setting information of at least one character of the plurality of characters.

In some embodiments, the image is generated with an image generation model, and/or the image presents an image identification of the user and at least one character of the plurality of characters.

In some embodiments, the ending page further includes a character list, and in the character list, at least one character of the plurality of characters is associated with an entry control. The apparatus 600 further includes an interaction module configured to, in response to detecting a trigger of an entry control associated with a first character in the character list, present a character page associated with the first character, the character page including at least one of: a dialogue window between the user and the first character, or a list of stories involving the first character. In some embodiments, the apparatus 600 further includes a selection module configured to: in response to detecting a trigger of the entry control associated with the first character, present a first option corresponding to the dialogue window and a second option corresponding to the list of stories involving the first character; present the character page including the dialogue window in response to detecting a selection of the first option; and present the character page including the list of stories involving the first character in response to detecting a selection of the second option.

In some embodiments, an order of the plurality of characters in the character list is determined based on at least one of: an occurrence order of the plurality of characters in the target story, a degree of closeness of interactions between the plurality of characters and the user in the target story, a character relationship between the plurality of characters and the user in the target story, or a degree of overall closeness of interactions between the plurality of characters and the user in respective stories involving the plurality of characters.

In some embodiments, the dialogue window with the first character is associated with the target story, and the apparatus 600 further includes a positioning module configured to position a process of the target story to a chapter involving the first character.

In some embodiments, the positioning module is further configured to, in response to detecting a trigger of the entry control associated with the first character, present a story chapter in the target story in which an interaction with the first character is required; and in response to detecting a selection of the story chapter in which the interaction with the first character is performed, position a process of the target story to the selected story chapter.

In some embodiments, the character page includes a dialogue window between the user and the first character, and the apparatus 600 further includes a reply module configured to determine, in the dialogue with the first character, a reply of the first character to the user based on at least one of: character setting information of the first character, historical dialogue information between the first character and the user in the target story, or historical dialogue information of the first character in stories other than the target story.

In some embodiments, the character page includes a list of stories involving the first character, the list including at least one of: introduction information of each story involving the first character, or character description information of the first character in each story.

In some embodiments, the character page includes a list of stories involving the first character, and the apparatus 600 further includes a third page presentation module configured to, in response to detecting a selection of a second story in the list of stories involving the first character, present a third page associated with the second story.

In some embodiments, the apparatus 600 further includes a sharing module configured to: in response to detecting a sharing request for a second character in the character list, receive an indication of a shared user of the second character; and send an access link corresponding to a character page associated with the second character to the shared user.

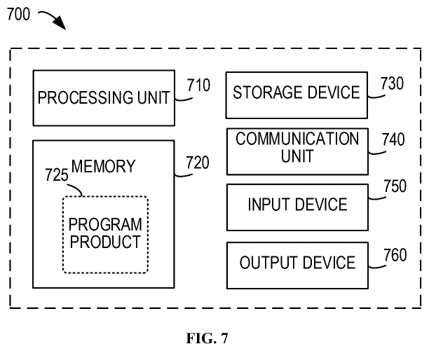

FIG. 7 illustrates a block diagram of an electronic device 700 in which one or more embodiments in the present disclosure may be implemented. It would be appreciated that the electronic device 700 illustrated in FIG. 7 is merely illustrative and should not constitute any limitation on the functionality and scope of the embodiments described herein. The electronic device 700 shown in FIG. 7 may be configured to implement the terminal device 110 in FIG. 1.

As shown in FIG. 7, the electronic device 700 is in the form of a general-purpose electronic device. Components of the electronic device 700 may include, but are not limited to, one or more processors or processing units 710, a memory 720, a storage device 730, one or more communication units 740, one or more input devices 750, and one or more output devices 760. The processing unit 710 may be an actual or virtual processor capable of performing various processes according to a program stored in the memory 720. In a multiprocessor system, a plurality of processing units execute computer-executable instructions in parallel to improve the parallel processing capabilities of electronic device 700.

The electronic device 700 typically includes a variety of computer storage media. Such media may be any available media that are accessible to the electronic device 700, including, but not limited to, volatile and non-volatile media, removable and non-removable media. The memory 720 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 730 may be a removable or non-removable medium and may include a machine-readable medium, such as a flash drive, magnetic disk, or any other medium that can be used to store information and/or data (for example, training data for training) and that can be accessed within the electronic device 700.

The electronic device 700 may further include an additional removable/non-removable, volatile/non-volatile storage medium. Although not shown in FIG. 7, a disk drive for reading from or writing to a removable, non-volatile magnetic disk (e.g., a “floppy disk”) or an optical disk drive for reading from or writing to a removable, non-volatile optical disk may be provided. In these cases, each drive may be connected to a bus (not shown) by one or more data media interfaces. The memory 720 may include a computer program product 725 having one or more program modules configured to execute various methods or actions of the various embodiments in the present disclosure.

The communication unit 740 is configured to communicate with other electronic devices through a communication medium. Additionally, the functionality of components of the electronic device 700 may be implemented by a single computing cluster or multiple computing machines capable of communicating through a communication connection. Thus, the electronic device 700 may operate in a networked environment using a logical connection with one or more other servers, network personal computers (PCs), or another network node.

The input device 750 may be one or more input devices such as a mouse, a keyboard, a trackball, or the like. The output device 760 may be one or more output devices, such as a display, a speaker, a printer, or the like. The electronic device 700 may also communicate with one or more external devices (not shown) through the communication unit 740 as needed. The external device, such as a storage device, a display device, etc., communicates with one or more devices that enable users to interact with the electronic device 700, or communicates with any device (e.g., a network card, a modem, etc.) that enables the electronic device 700 to communicate with one or more other electronic devices. Such communication may be performed via an input/output (I/O) interface (not shown).

According to example implementations in the present disclosure, a computer-readable storage medium having computer-executable instructions stored thereon is provided. The computer-executable instructions are executed by a processor to implement the method described above. According to example implementations in the present disclosure, a computer program product is further provided. The computer program product is tangibly stored on a non-transitory computer-readable medium and includes computer-executable instructions. The computer-executable instructions are executed by a processor to implement the method described above.

Various aspects in the present disclosure are described herein with reference to flowcharts and/or block diagrams of methods, apparatuses, devices, and computer program products implemented according to the present disclosure. It would be appreciated that each block of the flowchart and/or block diagram, and combinations of blocks in the flowcharts and/or block diagrams, may be implemented by computer readable program instructions.

These computer-readable program instructions may be provided to a processing unit of a general-purpose computer, special computer, or other programmable data processing apparatus to produce a machine that generates an apparatus to implement the functions/acts specified in one or more blocks in the flowchart and/or the block diagram when these instructions are executed through the processing units of the computer or other programmable data processing devices. These computer-readable program instructions may also be stored in a computer-readable storage medium. These instructions cause the computer, programmable data processing apparatus, and/or other devices to work in a specific way. Therefore, the computer-readable medium storing instructions includes an article of manufacture including instructions to implement aspects of the functions/acts specified in one or more blocks in the flowchart and/or block diagram(s).

The computer-readable program instructions may be loaded onto a computer, a programmable data processing apparatus, or a further device, such that a series of operational steps can be performed on the computer, programmable data processing apparatus, or the further device to produce a computer-implemented process. As such, the instructions executed on the computer, programmable data processing apparatus, or the further device implement the functions/acts specified in the one or more blocks in the flowchart and/or block diagram(s).

The flowchart and block diagrams in the drawings show the possible architecture, functions and operations of the system, the method, and the computer program product implemented according to various implementations in the present disclosure. In this regard, each block in the flowchart or block diagram may represent a part of a module, a program segment or instructions, which contains one or more executable instructions for implementing the specified logic function(s). In some alternative implementations, the functions marked in the blocks may also occur in a different order from those marked in the drawings. For example, two consecutive blocks may be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by a combination of a dedicated hardware and computer instructions.

Various implementations in the present disclosure have been described above. The above description is illustrative, not exhaustive, and the present application is not limited to the disclosed implementations. Without departing from the scope and spirit of the described implementations, many modifications and changes are obvious to those skilled in the art. The terminology used herein has been chosen to best explain the principles of the respective implementations, the practical applications or improvements to the technology in the marketplace, or to enable those skilled in the art to understand the implementations disclosed herein.

1. A method for page interaction, comprising:
detecting whether a story that a user is interacting with has ended, the story involving a plurality of characters and a storyline of the story being triggered based on setting information of the story and dialogues between the user and the plurality of characters; and
presenting an ending page corresponding to the story in response to detecting that the story has ended, the ending page comprising at least an interaction summary for the story, the interaction summary being generated based at least on the storyline triggered by the user in the story.

2. The method of claim 1, wherein the interaction summary is generated based at least on a dialogue between the user and at least one character of the plurality of characters in the storyline.

3. The method of claim 1, wherein the interaction summary is further generated based on character setting information of at least one character of the plurality of characters.

4. The method of claim 3, wherein the character setting information of the at least one character indicates at least a speaking style of the at least one character.

5. The method of claim 3, wherein the at least one character is selected from the plurality of characters based on at least one of:
a degree of closeness between a respective one of the plurality of characters and the user in the storyline,
a frequency of interaction between the respective one of the plurality of characters and the user in the storyline, or
respective character setting information of the plurality of characters in the story.

6. The method of claim 1, wherein the interaction summary comprises a summary part corresponding to the at least one character of the plurality of characters, the summary part corresponding to each character being further generated based on at least one of: a dialogue between the user and the character in the storyline, or character setting information of the character.

7. The method of claim 6, wherein the at least one character is selected by the user.

8. The method of claim 1, wherein the ending page further comprises an image generated based on at least one of:
the interaction summary,
the storyline of the story,
an ending of the story,
dialogues between the user and the plurality of characters in the storyline, or
character setting information of at least one character of the plurality of characters.

9. The method of claim 8, wherein the image is generated with an image generation model, and/or
wherein the image presents an image identification of the user and at least one character of the plurality of characters.

10. The method of claim 1, wherein the ending page further comprises a character list, and in the character list, at least one character of the plurality of characters is associated with an entry control, the method further comprising:
presenting a character page associated with a first character in response to detecting a trigger of an entry control associated with the first character in the character list, the character page comprising at least one of: a dialogue window between the user and the first character, or a list of stories involving the first character.

11. The method of claim 10, wherein presenting the character page associated with the first character in response to detecting the trigger of the entry control associated with the first character comprises:
presenting a first option corresponding to the dialogue window and a second option corresponding to the list of stories involving the first character in response to detecting the trigger of the entry control associated with the first character;
presenting the character page comprising the dialogue window in response to detecting a selection of the first option; and
presenting the character page comprising the list of stories involving the first character in response to detecting a selection of the second option.

12. The method of claim 10, wherein an order of the plurality of characters in the character list is determined based on at least one of:
an occurrence order of the plurality of characters in the story,
a degree of closeness of interactions between the plurality of characters and the user in the story,
a character relationship between the plurality of characters and the user in the story, or
a degree of overall closeness of interactions between the plurality of characters and the user in respective stories involving the plurality of characters.

13. The method of claim 10, wherein the dialogue window with the first character is associated with the story, and the method further comprises:
positioning at least one process of the story to a chapter involving the first character.

14. The method of claim 10, wherein positioning the process of the story to the chapter involving the first character comprises:
presenting at least one story chapter in the story in which an interaction with the first character is required in response to detecting the trigger of the entry control associated with the first character; and
positioning the at least one process of the story to a selected story chapter in response to detecting a selection of the story chapter in which the interaction with the first character is performed.

15. The method of claim 10, wherein the character page comprises the dialogue window between the user and the first character, the method further comprising:
determining, in the dialogue with the first character, a reply of the first character to the user based on at least one of:
character setting information of the first character,
historical dialogue information between the first character and the user in the story, or
historical dialogue information of the first character in stories other than the story.

16. The method of claim 10, further comprising:
receiving an indication of a user with whom a second character is shared in response to detecting a sharing request for the second character in the character list; and
sending an access link corresponding to the character page associated with the second character to the user with whom the second character is shared.

17-20. (canceled)

21. An electronic device, comprising:
at least one processor; and
at least one memory coupled to the at least one processor and storing instructions for execution by the at least one processor, wherein the instructions, when executed by the at least one processor, cause the electronic device to perform acts comprising:
detecting whether a story that a user is interacting with has ended, the story involving a plurality of characters and a storyline of the story being triggered based on setting information of the story and dialogues between the user and the plurality of characters; and
presenting an ending page corresponding to the story in response to detecting that the story has ended, the ending page comprising at least an interaction summary for the story, the interaction summary being generated based at least on the storyline triggered by the user in the story.

22. The electronic device of claim 21, wherein the interaction summary is generated based at least on a dialogue between the user and at least one character of the plurality of characters in the storyline.

23. The electronic device of claim 21, wherein the interaction summary is further generated based on character setting information of at least one character of the plurality of characters.

24. A non-transitory computer-readable storage medium having a computer program stored thereon, wherein the computer program is executable by a processor to implement acts comprising:
detecting whether a story that a user is interacting with has ended, the story involving a plurality of characters and a storyline of the story being triggered based on setting information of the story and dialogues between the user and the plurality of characters; and
presenting an ending page corresponding to the story in response to detecting that the story has ended, the ending page comprising at least an interaction summary for the story, the interaction summary being generated based at least on the storyline triggered by the user in the story.
